(19) United States
(12) Patent Application Publication
(10) Pub. No.: US 2017/0136355 A1
(43) Pub. Date: May 18, 2017

(54) SYNCHRONIZED MULTI-DEVICE MOBILE GAMING

(71) Applicant: Blackfire Research Corporation, San Francisco, CA (US)

(72) Inventor: Ravi Rajapakse, San Francisco, CA (US)

(21) Appl. No.: 15/389,438

(22) Filed: Dec. 22, 2016

Related U.S. Application Data
(63) Continuation-in-part of application No. 15/175,026, filed on Jun. 6, 2016, now abandoned.
Application No. 15/175,026 is a continuation-in-part of application No. 14/505,411, filed on Oct. 2, 2014, now Pat. No. 9,338,208.
Application No. 14/505,411 is a continuation of application No. 14/303,502, filed on Jun. 12, 2014, now Pat. No. 9,413,799.
Application No. 14/303,502 is a continuation-in-part of application No. 13/561,029, filed on Jul. 28, 2012, now Pat. No. 8,839,065.
Application No. 13/561,029 is a continuation-in-part of application No. 14/083,426, filed on Nov. 18, 2013, now Pat. No. 8,762,580.
Application No. 14/083,426 is a continuation of application No. 11/627,957, filed on Jan. 27, 2007, now Pat. No. 8,677,002.
Application No. 11/627,957 is a continuation-in-part of application No. 15/175,026, filed on Jun. 6, 2016, now abandoned.
Application No. 15/175,026 is a continuation-in-part of application No. 14/303,527, filed on Jun. 12, 2014, now Pat. No. 9,407,670.
Application No. 14/303,527 is a continuation-in-part of application No. 13/561,029, filed on Jul. 28, 2012, now Pat. No. 8,839,065.
Application No. 13/561,029 is a continuation-in-part of application No. 15/175,026, filed on Jun. 6, 2016, now abandoned.
Application No. 15/175,026 is a continuation-in-part of application No. 14/303,527, filed on Jun. 12, 2014, now Pat. No. 9,407,670.
Application No. 14/303,527 is a continuation-in-part of application No. 14/083,426, filed on Nov. 18, 2013, now Pat. No. 8,762,580.
Application No. 14/083,426 is a continuation-in-part of application No. 15/175,026, filed on Jun. 6, 2016, now abandoned.
Application No. 15/175,026 is a continuation-in-part of application No. 15/047,548, filed on Feb. 18, 2016.
(60) Provisional application No. 61/833,927, filed on Jun. 12, 2013.
(60) Provisional application No. 60/766,573, filed on Jan. 28, 2006.
(60) Provisional application No. 61/833,928, filed on Jun. 12, 2013.
(60) Provisional application No. 61/512,924, filed on Jul. 29, 2011.
(60) Provisional application No. 61/833,928, filed on Jun. 12, 2013.
(60) Provisional application No. 61/727,624, filed on Nov. 16, 2012.
(60) Provisional application No. 62/171,217, filed on Jun. 4, 2015.
(60) Provisional application No. 62/117,899, filed on Feb. 18, 2015.

(51) Int. Cl. A63F 13/31; A63F 13/92

(52) U.S. Cl. CPC A63F 13/31; A63F 13/92

(57) ABSTRACT

A system for synchronized multi-device mobile gaming, comprising a synchronization module that receives a game state from a software game application operating on the computing device, transmits at least a portion of the game state via a network, receives synchronization data comprising at least a state update message via the network, and updates at least the game state based at least in part on the received synchronization data, and a method for synchronizing multi-device mobile gaming.

### CROSS-REFERENCE TO RELATED APPLICATIONS

This application is a continuation-in-part of U.S. patent application Ser. No. 15/175,026, titled “SYNCHRONIZED MULTI-DEVICE MOBILE GAMING”, and filed on Jun. 6, 2016, which is a continuation-in-part of U.S. patent application Ser. No. 14/505,411, titled “COMMON EVENT-BASED MULTIDEVICE MEDIA PLAYBACK” and filed on Oct. 2, 2014, now issued as U.S. Pat. No. 9,338,208 on May 10, 2016, which is a continuation of U.S. patent application Ser. No. 14/303,502, titled “SYNCHRONOUS PLAYBACK OF MEDIA USING A WI-FI NETWORK WITH THE MEDIA ORIGINATING FROM A BLUETOOTH SOURCE”, filed on Jun. 12, 2014, which claims the benefit of, and priority to, U.S. provisional patent application Ser. No. 61/833,927, titled “SYNCHRONOUS PLAYBACK OF MEDIA USING A WI-FI NETWORK WITH THE MEDIA ORIGINATING FROM A BLUETOOTH SOURCE”, filed on Jun. 12, 2013, the entire specifications of each of which are incorporated herein by reference in their entirety, and is also a continuation-in-part of U.S. patent application Ser. No. 13/561,029, titled “PACKET LOSS ANTICIPATION AND PRE EMPTIVE RETRANSMISSION FOR LOW LATENCY MEDIA APPLICATIONS” filed on Jul. 28, 2012, now issued as U.S. Pat. No. 8,839,065 on Sep. 16, 2014, and is also a continuation-in-part of U.S. patent application Ser. No. 14/083,426, titled “COMMON EVENT BASED MULTI DEVICE PLAYBACK”, filed on Nov. 16, 2013, now issued as U.S. Pat. No. 8,762,580 on Jun. 24, 2014, which is a continuation-in-part of U.S. patent application Ser. No. 11/627,957, titled “Streaming Media System and Method” and filed on Jan. 27, 2007, now issued as U.S. Pat. No. 8,677,002 on Mar. 18, 2014, and claims the benefit of, and priority, to U.S. provisional patent application Ser. No. 61/727,624, filed on Nov. 16, 2012, titled “COMMON EVENT-BASED MULTIDEVICE MEDIA PLAYBACK”, the entire specifications of each of which are incorporated herein by reference in their entirety.

This application is a continuation-in-part of U.S. patent application Ser. No. 15/175,026, titled “SYNCHRONIZED MULTI-DEVICE MOBILE GAMING”, and filed on Jun. 6, 2016, which a continuation-in-part of U.S. patent application Ser. No. 14/303,527, titled “BROADCASTING MEDIA FROM A STATIONARY SOURCE TO MULTIPLE MOBILE DEVICES OVER WI-FI” and filed on Jun. 12, 2014, which claims the benefit of, and priority to, U.S. provisional patent application Ser. No. 61/833,928, titled “BROADCASTING MEDIA FROM A STATIONARY SOURCE TO MULTIPLE MOBILE DEVICES OVER WI-FI”, filed on Jun. 12, 2013, the entire specification of which is incorporated herein by reference, and is also a continuation-in-part of U.S. patent application Ser. No. 13/561,029, titled “PACKET LOSS ANTICIPATION AND PRE EMPTIVE RETRANSMISSION FOR LOW LATENCY MEDIA APPLICATIONS” filed on Jul. 28, 2012, now issued as U.S. Pat. No. 8,839,065 on Sep. 16, 2014, and is a continuation-in-part of U.S. patent application Ser. No. 14/083,426, titled “COMMON EVENT BASED MULTI DEVICE PLAYBACK, filed on Nov. 16, 2013, which is a continuation-in-part of U.S. patent application Ser. No. 11/627,957, titled “Streaming Media System and Method” and filed on Jan. 27, 2007, and also claims a benefit of, and priority, to U.S. provisional patent application Ser. No. 61/727,624, filed on Nov. 16, 2012, titled “COMMON EVEN BASED MULTIDEVICE MEDIA PLAYBACK” the entire specification of each of which is incorporated herein by reference.

This application is a continuation-in-part of U.S. patent application Ser. No. 15/175,026, titled “SYNCHRONIZED MULTI-DEVICE MOBILE GAMING”, and filed on Jun. 6, 2016, which claims the benefit of and priority to U.S. provisional application Ser. No. 62/171,217 titled “SYNCHRONIZED MULTI-DEVICE MOBILE GAMING” filed on Jun. 4, 2016, the entire specification of which is incorporated herein by reference in its entirety.

### BACKGROUND OF THE INVENTION

Field of the Art

The disclosure relates to the field of digital media, and more particularly to the field of synchronized gaming using multiple mobile electronic devices.

Discussion of the State of the Art

In the field of electronic gaming, it is common for multiple players to want to jointly participate in a cooperative or competitive game together, either while in close proximity to each other (such as in a home) or across wide distances using network connectivity. It is generally accepted that network-based gaming there may be some technical hurdles such as network latency or packet loss, and these often manifest as noticeable degradation in a gaming experience for a player (such as lowered video frame rate causing stuttering movement, for example). Even in a high-speed local network connection these issues can occur, as they are an inherent factor present in any packet-based timing as is generally employed in gaming to send game state information to players.

Additionally, it is becoming increasingly common for players to wish to stream their gameplay to external devices such as speakers, cameras, or video displays, either in whole (such as popular streaming broadcast services like TWITCH™) or in part (such as streaming audio to a number of “surround” speakers, or streaming video to an external display for greater visibility). As with network-based multiplayer gaming, this introduces technical difficulties with latency and stuttering, as well as a phenomenon known as “input lag” wherein a player's actions are reflected with a delay owing to the technical issues present in packet-based timing.

What is needed, is a means to enable synchronized multi-device gaming without the issues inherent in packet-based timing schema currently employed in the art, as well as enabling synchronized streaming or broadcast of audio or video content during a game to external devices.

### SUMMARY OF THE INVENTION

Accordingly, the inventor has conceived and reduced to practice, in preferred embodiments, a system and method for synchronized gaming using multiple mobile electronic devices.

To fulfill the desire of electronic gamers to play cooperative or competitive games on their network capable mobile devices that are synchronized over a network the inventors conceived and reduced to practice a system where a game of choice may be played over a network such as WIFI™, mobile phone data networks such as LTE™ and WIMAX™, or BLUETOOTH™, depending on the circumstances. The play state of the game remains synchronized whether the players are within feet or yards of each other or are distributed throughout the globe. Game play using the system works equally well whether the game is being run on a managed network with centralized access point or when the game devices form more fluid ad hoc or mesh type network topologies.

According to a preferred embodiment, a system for synchronized multi-device mobile gaming, comprising a synchronization module comprising at least a plurality of programming instructions stored in a memory and operating on a processor of a network-connected computing device and configured to: receive at least a game state from a software game application operating on the computing device; transmit at least a portion of the game state via a network; receive synchronization data comprising at least a state update message via the network; and update at least the game state based at least in part on the received synchronization data, is disclosed.

According to another preferred embodiment of the invention, a method for synchronized multi-device mobile gaming, comprising the steps of: receiving, at a synchronization module comprising at least a plurality of programming instructions stored in a memory and operating on a processor of a network-connected computing device and configured to receive at least a game state from a software application operating on the computing device, and configured to transmit at least a portion of the game state via the network, and configured to receive at least a state update via the network, and configured to update at least the game state based at least in part on the received state update, a plurality of state update messages via a network; updating at least the operational state of a running software game application based at least in part on at least a portion of the received state update messages; and transmitting at least the updated operational state via the network, is disclosed.

### BRIEF DESCRIPTION OF THE DRAWING FIGURES

The accompanying drawings illustrate several embodiments of the disclosed configuration and, together with the description, serve to explain the principles of the invention according to the embodiments. One skilled in the art will recognize that the particular embodiments illustrated in the drawings are merely exemplary, and are not intended to limit the scope of the disclosed embodiments.

FIG. 1 is an illustration of a server-oriented system for synchronized multi-device mobile gaming, according to a preferred embodiment of the invention.

FIG. 2 is an illustration of an ad-hoc system for synchronized multi-device mobile gaming, according to a preferred embodiment of the invention.

FIG. 3 is an illustration of an exemplary method for providing a synchronized gaming experience on a mobile device, according to a preferred embodiment of the invention.

FIG. 4 is a block diagram illustrating an exemplary use case for a system for synchronized multi-device mobile gaming, utilizing a media computing device connected to a television and multiple speakers.

FIG. 5 is a block diagram illustrating an exemplary use case for a system for synchronized multi-device mobile gaming, utilizing discrete audio zoning for multiple devices.

FIG. 6 is a block diagram illustrating an exemplary hardware architecture of a computing device used in an embodiment of the invention.

FIG. 7 is a block diagram illustrating an exemplary logical architecture for a client device, according to an embodiment of the invention.

FIG. 8 is a block diagram showing an exemplary architectural arrangement of clients, servers, and external services, according to an embodiment of the invention.

FIG. 9 is another block diagram illustrating an exemplary hardware architecture of a computing device used in various embodiments of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

The term “Unicast” may be used to refer to a type of Internet Protocol transmission in which information is sent from only one sender to only one receiver. In other words, unicast transmission is a one-to-one node transmission between two nodes only. In unicasting each outgoing packet has a unicast destination address, which means it is destined for a particular destination that has that address. All other destinations that may hear that packet ignore the packet, if the packet's destination address is not the same as that destination's address.

As used herein, “broadcast messaging” or “broadcasting” refers to a type of Internet Protocol transmission in which information is sent from just one computer, but is received by all the computers connected on the network. This would mean that every time a computer or a node transmits a “broadcast” packet, all the other computers could receive that information packet.

As used herein, “multicast messaging” or “multicasting” refers to a type of Internet Protocol transmission or communication in which there may be more than one sender and the information sent is meant for a set of receivers that have joined a multicast group, the set of receivers possibly being a subset of all the receivers. In multicasting, each multicast packet is addressed to a multicast address. This address is a group address. Any destination can subscribe to the address and therefore can listen and receive packets sent to the multicast address that it subscribed to. The benefit of multicasting is that a single multicast packet sent can be received by multiple destinations. This saves network traffic if the same packet needs to be sent to multiple destinations. When the same data needs to be sent to multiple IP destinations generally, broadcasting or multicasting, rather than unicasting, provides the most efficient use of the network.

In this description the terms broadcast and multicast may be used. In both broadcasting and multicasting, when messages are sent, they are received by multiple destinations. Therefore, as used herein, the terms broadcast and multicast may be used interchangeably to refer to one packet being received by multiple destinations. In some cases, this description only refers to the media being sent or transmitted without specifying whether it is broadcast, multicast or unicast. In such case, it means any one of these methods may be used for sending or transmitting the media.

As used herein, the terms “message” and “packet” are often used and may be used interchangeably. A packet is a data set to be sent or received on an Internet Protocol (“IP”) network. The packet may or may not be the same as an “IP packet”. The term “message”, as used herein, refers to the logical information contained in such a packet.

As used herein, the “segment” may also be used to refer to a data set. A data set is a set of bytes of data. Data may be any type of data, including media or control or informational data. In this description the term data and packet may also be used interchangeable depending on context. “Packet” may refer to a data set and data refers to data in general.

Numerous alternative embodiments are disclosed herein; it should be understood that these embodiments are presented for illustrative purposes only. The described embodiments are not intended to be limiting in any sense. In general, embodiments are described in sufficient detail to enable those skilled in the art to practice one or more of the inventions, and it is to be understood that other embodiments may be utilized and that structural, logical, software, electrical and other changes may be made without departing from the scope of what is disclosed.

According to an embodiment of the invention, in order to broadcast media over a Wi-Fi network, it is first necessary to recognize that broadcast or multicast media will not be received at all destinations uniformly. Some destinations will receive a multicast “packet” (referring to a data set to be sent or received on an Internet Protocol (“IP”) network. The packet may or may not be the same as an “IP packet”. The term “message”, as used herein, refers to the logical information contained in such a packet; may also be referred to interchangeably as a “message”, or “segment”), while others will not.

IP networks were first designed to operate over wired networks. By design, the packet communications on these networks were “best effort”. This means any packet transmitted on the network may not be received by the intended destination. This is most often due to a collision, where another device starts to communicate at the same moment as the device of interest, thereby causing a collision. Another method of loss would be the devices in the network path, such as routers, simply dropping the packet, for example due to the lack of buffer space. Other reasons for loss could be that the wired line is simply noisy and the packet transmission got corrupted, though this is rare for the wired case vs. the wireless case.

In all these wired situations it is generally the case that, if the transmission (for example, a multicast message), was received by one device on a subnet or wire, all the other devices on the same wire or subnet would also receive the transmission correctly. This is because in the wired case, the noise or interference situation of a device on one part of the wire is not so different from the noise situation at another part of the wire. If the wired devices are connected via a switch rather than a hub, the same issues are true, and the amount of noise or interference is minimal. In Wi-Fi, the differences in receipt of Wi-Fi traffic at each Wi-Fi device in a subnet are substantial. Therefore, it is necessary to account for this.

The system uses common event synchronization where a centralized gaming server or, in other scenarios, one of the participating game devices, acts as a synchronization hub, sending recurring, uniquely identified, messages to all other participating game devices and awaiting responses from each. Round-trip transit time data for these messages from each participating game device allows calculation of network transit time to individual nodes. Presentation of current game play state is then adjusted so that all game devices render game progress to gamers simultaneously. Common event synchronization works equally well when coupled to games being served to each game device from a centralized game server and when there is no centralized server, each game device has its own copy of the game application and all that is exchanged are game state updates as the game progresses.

For role playing games, the system can make use of common event synchronization and positional data gleaned from each of the mobile game devices to create individualized game instances for each player that simulates the player's spatial relationship to other players. For example, where appropriate, a game player gets a view from a vantage point to the right of a player to her left and in front of a player behind her. These relationships can, of course be modified so that gamers separated by many miles would differ by only feet or yards in the game or so that spatial order is modified and in game movements by the players are relative to the modified order.

These characteristics of highly modifiable network topologies that can be chosen to match available resources and player group penchant, a robust method to maintain synchronized game state for all participating mobile game devices, and works under multiple modes of game function and the ability to use gaming device location service to adjust players' vantage point within a game programmed to take advantage of the features, embodies a strong and useful mobile gaming system.

In many media systems it is desirable to send the media to multiple playback devices and have each playback device render the media in phase. For example, it is desirable to send the left channel of stereo audio media to the left audio playback device and the right channel of the stereo media to the right audio playback device and to have both these devices play the media correctly in phase.

### DETAILED DESCRIPTION OF EXEMPLARY EMBODIMENTS

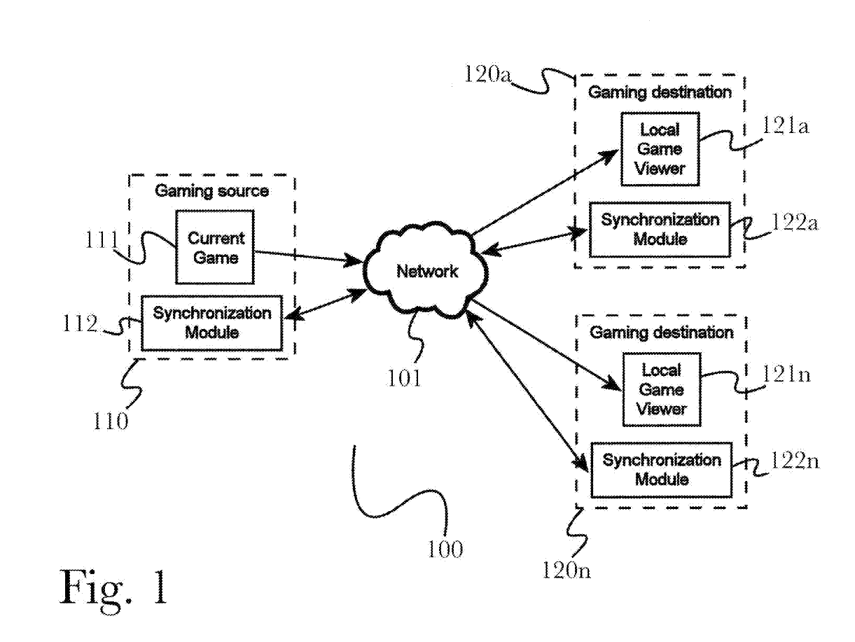

FIG. 1 is an illustration of a server-oriented system 100 for synchronized multi-device mobile gaming, according to a preferred embodiment of the invention. According to the embodiment, a gaming source device 110 may comprise a plurality of programming instructions stored in a memory and operating on a network-connected computing device, and may be adapted to operate a software-based game 111 and communicate game information via a network 101 such as the Internet or other suitable data communication network, for example via Wi-Fi, BLUETOOTH™ or other suitable communication mechanisms or protocols according to a particular arrangement or use. Gaming source 110 may further comprise a synchronization module 112 that may direct a local clock and generate timing events based at least in part on local clock timing. A plurality of gaming destination devices 120a-n may receive game information via a network 101 from gaming source 110 (such as current game state information), or synchronization information such as timing events based on a local clock operating on gaming source 110. A gaming destination device 120a may operate a synchronization module 122a that may receive and process timing events or other synchronization information from a gaming source 110, and may then direct a local clock operating on gaming destination device 120a to update based at least in part on received synchronization information, and a local game state may be updated to reflect a current, synchronized game state based at least in part on received game state or synchronization information, and a device may then present a current game state to a user via a local game viewer 121a (for example, so that a user may view the current game from their particular perspective, while maintaining a synchronized and up-to-date overall game state). In this manner, gaming device 120a may be kept in sync with gaming source 110, ensuring that a game may be played without skipping, stuttering, “lag”, or other common synchronization issues that may occur when playing network-based electronic games. Additionally, each of a plurality of gaming destination devices 120a-n may operate a local viewer 121a-n for a game, allowing users to see their particular viewpoint of a game (such as their pieces on a virtual game board, or a game perspective through their particular character's viewpoint, or other such player-specific point-of-view information according to the nature of a particular game being played), while an internal state for the game overall (that is, an entire game state rather than just information pertaining to a particular player or device) may be kept current and in sync with other players via synchronization information from gaming source 110.

A particular example of a server-oriented multi-device mobile gaming according to the embodiment, may be a common scenario of several users wishing to play a game operating on a web-hosted server, such as an online roleplaying game (RPG). Each player may connect to a server using their particular device, such as a smartphone or tablet computing device (it should be appreciated that the specific design and nature of gaming devices may vary widely according to a particular arrangement or the nature of a particular game being played, for example for web-based or software app-based games), and the server may then operate an “instance” of the game unique to the group. It is common practice for gaming servers to operate a number of instances in such a manner, and instances may be used to enable players to play together within a single game (such as playing different characters together in an RPG, or playing different teams or colors in a virtual board game, or other cooperative or competitive group play), while also enforcing boundaries to prevent unwanted players from joining or interfering with a game. The server may operate the game instance and send state information to each player's device, ensuring they are kept up to date with regard to the game state (such as game progression or player info like character statistics or turn order), and may also send synchronization information to ensure that player devices are kept synchronized relative to each other and relative to the server (for example, to prevent some players from seeing an update to the game state before others do, as might confer an unfair advantage). As players take turns, perform actions, or otherwise interact with the game, their devices may send game state updates to the server for processing. The server may then update a current game state and provide the updated information to all player devices, ensuring everyone has access to the same game information and keeping all players current as the game progresses. In this manner, a centralized server may operate a game for a plurality of players and enforce synchronicity between all participants as well as maintain a current game state, while updating devices as appropriate based on input from each player to provide an orderly gameplay experience.

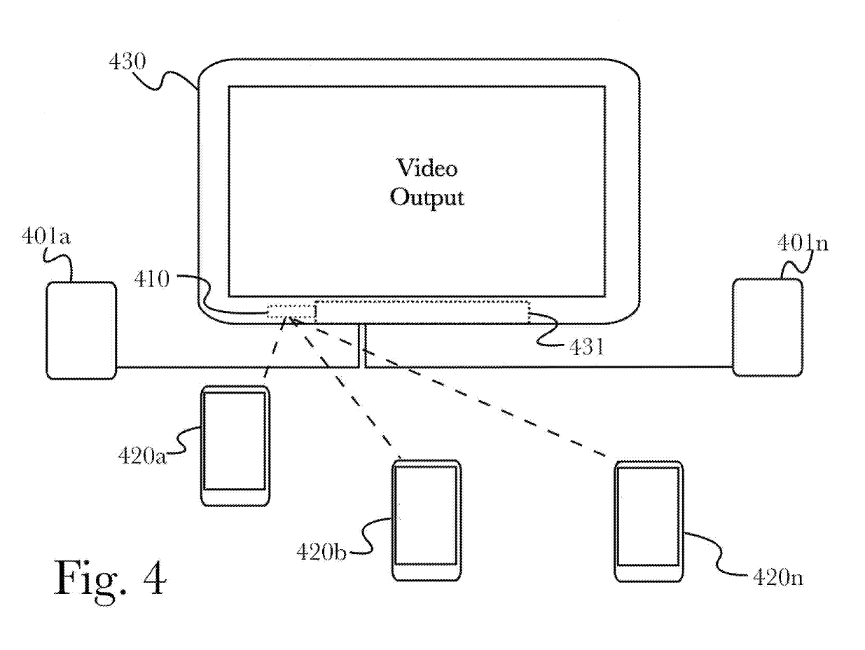

In some arrangements, a gaming source 110 or destination 120a-n may be a media computing device that connects to external hardware such as speakers or a video display (for example, a CHROMECAST™ device connected to a television). In such an arrangement, the media computing device may operate a synchronization module 112 and communicate with mobile devices in use by players, operating interchangeably as a destination (for example, for a user to broadcast some or all of their game content to the media computing device, such as sending audio for playback via speakers or video for viewing on a TV) or source (such as to host a game for players to participate via their mobile devices), according to a particular game or use case. Use of a media computing device is described below in greater detail, referring to FIG. 4.

It should be appreciated that a network 101 may be any suitable communication network for conveying information between devices according to the embodiment, and that various arrangements may be possible according to a particular network technology or architecture. For example, several users in close proximity to each other may play a game operating on a server device nearby over a local area network (LAN) connection, for example users on household gaming consoles such as a Microsoft XBOX™ or Sony PLAYSTATION™ device as two of multiple examples. Alternately, several users may connect individually to a server over an Internet connection, as is common with massively multiplayer online (MMO) style games, where players may be located across the globe while connecting to a central server over the Internet for group play.

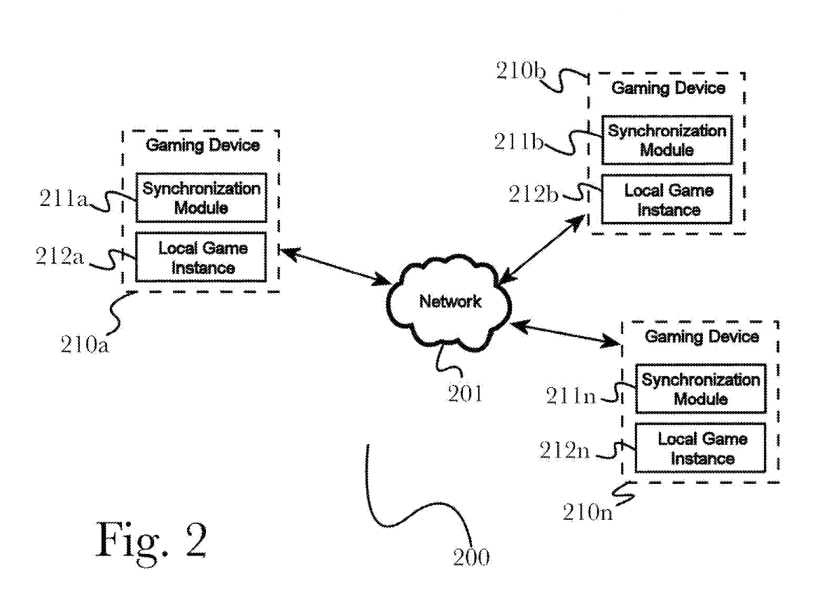

FIG. 2 is an illustration of an ad-hoc system 200 for synchronized multi-device mobile gaming, according to a preferred embodiment of the invention. According to the embodiment, a plurality of gaming devices 210a-n may communicate via a network 201 such as the Internet or other data communication network. According to the embodiment, a gaming device 210a may operate a synchronization module 211a that may direct a local clock operating on gaming device 210a and generate timing events based at least in part on a local clock timing. Gaming device 210a may operate a local game instance 212a, comprising a running software game operating on gaming device 210a. During operation, gaming device 210a may send game state information (based at least in part on a current state of a running local game instance 212a) and synchronization information (such as timing events produced by a synchronization module 211a) to another gaming device 210b via network 201. Gaming device 210b may then operate a synchronization module 211b that may direct a local clock to update based at least in part on received timing events or other synchronization information, and gaming device 210b may update a running local game instance 212b based at least in part on received game state information. This operation may be repeated for any number of additional gaming devices 210n, enabling an arbitrarily large number of players to participate.

According to the embodiment, gaming devices 210a-n may communicate directly with one another via a network, rather than (as previously described, referring to FIG. 1) communicating with a singular server device. To further expand this method of operation, various means of ad-hoc or “mesh” networking may be utilized, wherein devices may directly connect to one another via any available network connectivity means, forming a network as needed rather than connecting individually to a pre-existing network.

An example of an ad-hoc system 200 may be a number of users operating mobile devices such as smartphones, playing an app-based game that utilizes network communication (such as, for example, a competitive puzzle game). Due to the mobile nature of their devices, it may be desirable for users to be able to connect and play with each other without the use of a pre-existing network or a game server—for example, friends traveling together on an airplane and wishing to play a game to pass the time. Users may be able to view nearby players or select known players (such as from a contact list stored on their device) to play with, and their device may directly connect as needed so they may play a game regardless of network or server availability.

In either a server-oriented or ad-hoc arrangement as described above (referring to FIGS. 1-2), it should be appreciated that a single game state may be maintained across devices, while each device may present a player with their own player-specific rendition of a game state reflecting their own point of view within the game (such as viewing their pieces on a game board or their character's information, or other player-specific game data according to the nature of game being played), rather than simply conveying a pre-rendered game state to all players (which would result in all players seeing the same game, for example an “omniscient” viewpoint rather than their player-specific, limited view). It should be further appreciated that the specific nature of a game state presented to each device (and thus, to each player or user of a device) may vary according to a particular game or game type being played. For example, in a roleplaying game it may generally be desirable for each player to only have access to their specific character information, encouraging immersion or a more realistic type of gameplay, whereas a chess game (for example) may present an overview of a game board to players as they would be able to see all pieces on a physical board and the ability to see other players' pieces has no effect on the gameplay or outcome.

In either a server-based or ad-hoc multi-device gaming arrangement, it should be appreciated that the specific nature of a gaming device may vary considerably and that devices with various hardware or software capabilities may be utilized interchangeably or simultaneously according to the embodiment disclosed herein. Furthermore, multi-device gaming may be enhanced through the use of synchronized multi-device media playback according to the embodiments, for example to enable multi-device gaming between several users while also allowing some or all users to stream or broadcast media from their device to a plurality of external receivers such as audio speaker devices or video displays. For example, several players may choose to play a roleplaying game together in a local area such as a home, each using their own gaming device such as a smartphone or personal computer. In a server-oriented arrangement, a server hosting the game for the players may broadcast audio to a set of multi-channel or surround speaker devices (for example), for example to simulate immersion in the game's virtual world being shared by all players present. Alternately, in an ad-hoc arrangement, an individual player using a smartphone may choose to stream their game's video content to an external display such as a television or computer monitor, for example to enjoy a larger view of a game in progress (rather than the comparatively small view offered by a smartphone). In this manner it can be appreciated that multi-device gaming and multi-device media playback may be used simultaneously to enhance a gaming experience, providing synchronization of both a game state and audio or video media associated with a game for some or all players according to various arrangements.

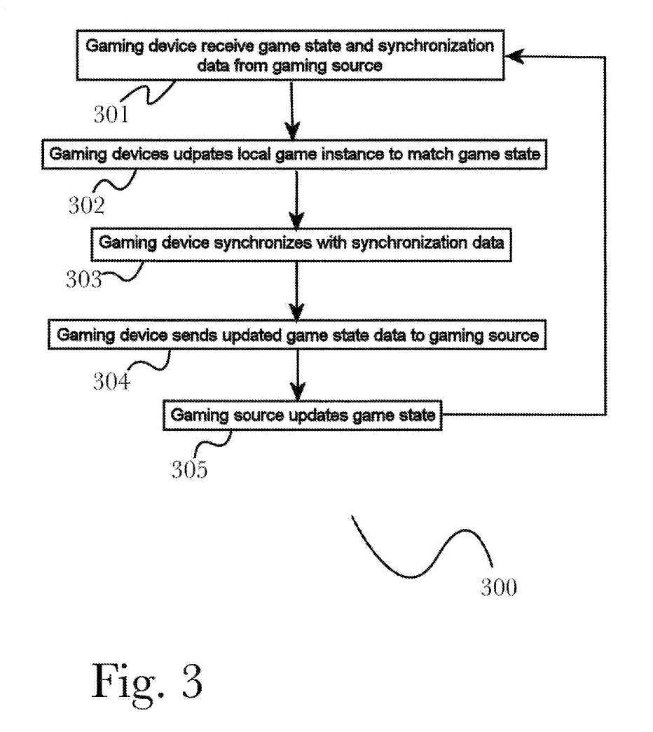

FIG. 3 is an illustration of an exemplary method 300 for providing a synchronized gaming experience on a mobile device, according to a preferred embodiment of the invention. In an initial step 301, a gaming device (such as a smartphone or other computing device suitable for operating a software-based game) may receive a plurality of game state and synchronization information from a gaming source such as a server device or another gaming device (according to a server-oriented or ad-hoc arrangement, as described previously referring to FIGS. 1-2). Received information may comprise a variety of information describing a current state of a game in progress (such as turn order or actions taken by other players or computer-controlled entities or events), or timing events based on device clock timing as may be produced by a synchronization module. In a next step 302, the gaming device may update a local game instance based at least in part on received game state information, for example to reflect actions taken on another player's turn or to increment a progression counter such as a game clock. In a next step 303, the gaming device may synchronize according to received synchronization data, such as by directing a local clock to adjust its timing based on received timing events produced by a synchronization module operating on another device (such as a gaming source or another gaming device). In a next step 304, the gaming device may then send updated game state information to a gaming source (such as a server or another gaming device), for example to provide actions taken by a user of the gaming device (such as a player taking their turn). In a final step 305, a game state may be updated by a gaming source to reflect received updated game information, and operation may then continue in an iterative or looping fashion returning to step 301 with a gaming device receiving the new, updated game state information to continue operation.

It should be appreciated that a “gaming source” according to the method described according to the embodiment may be any suitable device that may send game state or synchronization information, and may be a server device or another gaming device such as a smartphone or other user device, according to a particular arrangement or use case. For example, in an ad-hoc arrangement such as described previously (referring to FIG. 2), each of a plurality of user devices may be considered both a gaming source and a gaming destination device, as each device may receive game and synchronization information, process game updates and perform synchronization adjustments, generate new information, and provide newly-generated information to other connected devices. It may therefore be appreciated that while reference is made herein to gaming source and gaming destination devices in particular, or gaming devices in general, such description is meant as exemplary and is provided to describe the operations being performed at a device rather than its inherent nature or capabilities, and that devices may be used alternately or simultaneously in various roles. Additionally, it should be appreciated that while reference may be made to a device in the singular, any number of devices may be utilized to perform a particular function or to fill a particular role, such as utilizing an arbitrarily large number of gaming devices in an ad-hoc arrangement, or utilizing multiple servers in a server-oriented arrangement, or any other various combinations of devices as appropriate according to an arrangement or use case.

FIG. 4 is a block diagram illustrating an exemplary use case for a system 400 for synchronized multi-device mobile gaming, utilizing a media computing device connected to a television and multiple speakers. According to the embodiment, a media computing device 410 may be connected to an appropriate hardware port (for example, an HDMI or DisplayPort video port) on the back 431 connection panel of a television 430 or similar video device (for example, in some arrangements a computer display monitor, projector, or other video device may be used). When connected in this fashion, media computing device 410 may also draw power for operation from television 430, removing the need for any additional cables or connections. television 430 may also be connected to a plurality of external hardware speakers 401a-n, as is common in home media arrangements where the television 430 displays video content and speakers 401a-n are used to playback corresponding audio content during viewing. Media computing device 410 may be further connected via wireless network connections to a plurality of user mobile devices 420a-n, for example a plurality of smartphone devices as shown (however it should be appreciated that various types of device may be used, for example tablet computing devices or laptop personal computers, or any other device capable of communicating with media computing device 410 via a wireless network connection). While connected in this manner, a media computing device 410 may operate as a gaming source 110, providing game information to a plurality of mobile devices 420a-n operating as gaming destinations 120a-n. Media computing device 410 may also operate as a gaming destination 120a, for example to receive game information such as audio or video content from a mobile device 4120a operating as a gaming source device 110, such as when a user playing a game on their mobile device 420a wishes to stream content to a TV 430 for viewing by others, or to stream audio to speakers 401a-n using media computing device 410 as an audio receiver, such as to enjoy a multichannel audio experience while gaming (for example, for immersion or to utilize positional audio).

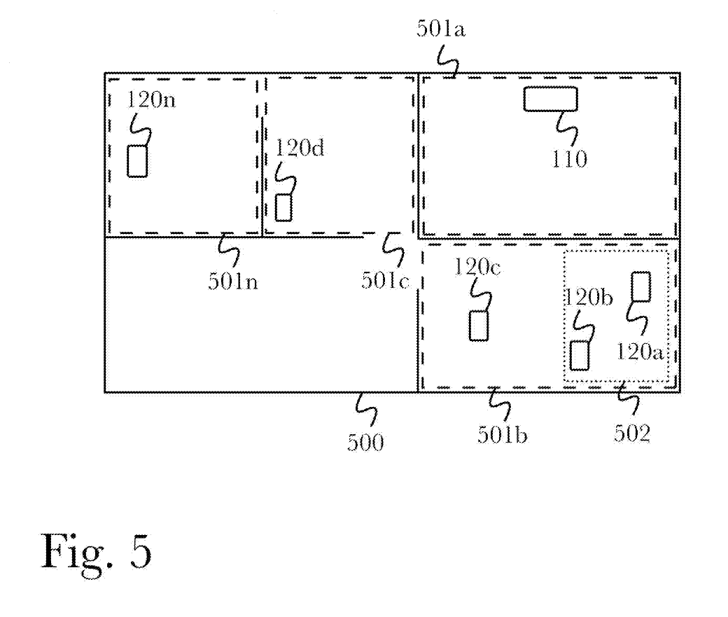

FIG. 5 is a block diagram illustrating an exemplary use case for a system for synchronized multi-device mobile gaming, utilizing discrete audio zoning for multiple devices. According to the embodiment, a plurality of mobile devices may operate as gaming destinations 120a-n in different locations, such as (for example) rooms within a building 500. A gaming source device 110 may be located separately from gaming destinations as illustrated, or may optionally be located near some or all gaming destinations, and it should be appreciated that various arrangements of devices and locations may be possible according to the embodiment. Gaming devices (both source and destination, according to a particular game, arrangement, or use case) may be grouped and separated into “zones” 501a-n, that may be determined optionally either by manual configuration (for example, players may define zones as part of game setup or configuration) or automatically by a game source 110, such as using spatial or signal information. For example, a gaming source 110 with appropriate imaging hardware may be able to scan a space and determine one or more optimal zone configurations, or may use network signal strength information (for example, as reported by gaming destination devices 120a-n) to configure zones without visual information about a space.

Zones 501a-n may be used to establish spatial boundaries in physical space that may have in-game use, such as crossing from one zone to another to interact with a game via movement or position, or they may be used to group or identify players of a game, such as to separate teams by physical location or to use player positioning within a zone arrangement to interact with their in-game performance. One example may be in a roleplaying game, players may be restricted to interacting only with others in their zone, using player position to facilitate a level of immersion in the setting of the game by incorporating real-world position and movement and utilizing it for game interaction. Another use for this real-world integration may be for adversarial games, grouping players into teams by zone and encouraging competitive play by using zones to model in-game “territory” for various purposes such as capture-based gameplay.

Additionally, according to some arrangements there may be zones 502 configured within larger zones 501b, that may optionally utilize nested permissions or functions. For example, in a strategy game there may be an inner zone 502 that is used for high-ranking players of one team, while a larger zone 501b is used for the team as a whole. This may be used, for example, to facilitate granular interaction or immersion within zones for individual players or groups.

Another use for zones may be to group game information such as video, audio, or other available game data by zone. For example, players may share audio data (that is, ambient audio and other game audio data playing on their devices may be the same) within a zone, but moving into another zone separates a player from that audio group and places them into the group for the new zone, with separate audio that is not heard by players outside of that zone. This may be used to facilitate cooperative or competitive gameplay by allowing players to coordinate efforts within a zone, while maintaining a “fog of war” via zone boundaries, and may also be used to facilitate immersion by using position-based audio such as to have ambient music or sound effects for different zones to indicate their in-game information. For example, in a role-playing game, one zone may have ambient sound effects such as water dripping or echoes, indicating the zone's use as a cave or similar interior location within the game. It should be appreciated that various additional and alternate arrangements and uses for zones may be possible according to the embodiment, and those described are merely exemplary.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

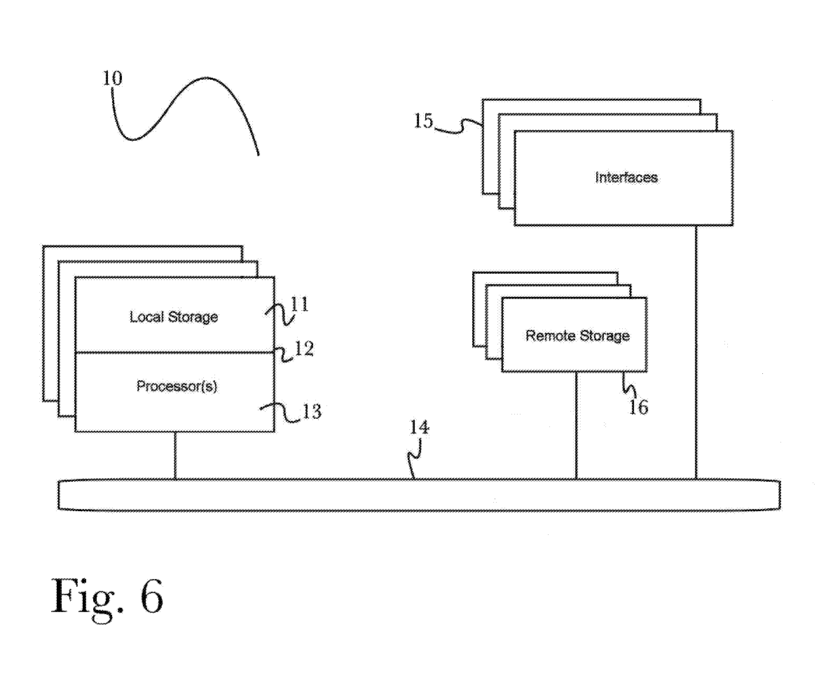

Referring now to FIG. 6, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 6 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

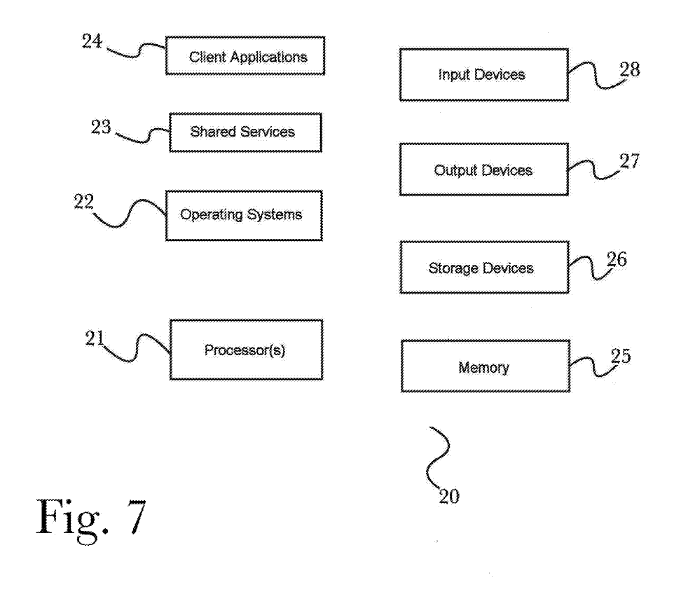

In some embodiments, systems according to the present invention may be implemented on a standalone computing system. Referring now to FIG. 7, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 6). Examples of storage devices 26 include flash memory, magnetic hard drive, CD-ROM, and/or the like.

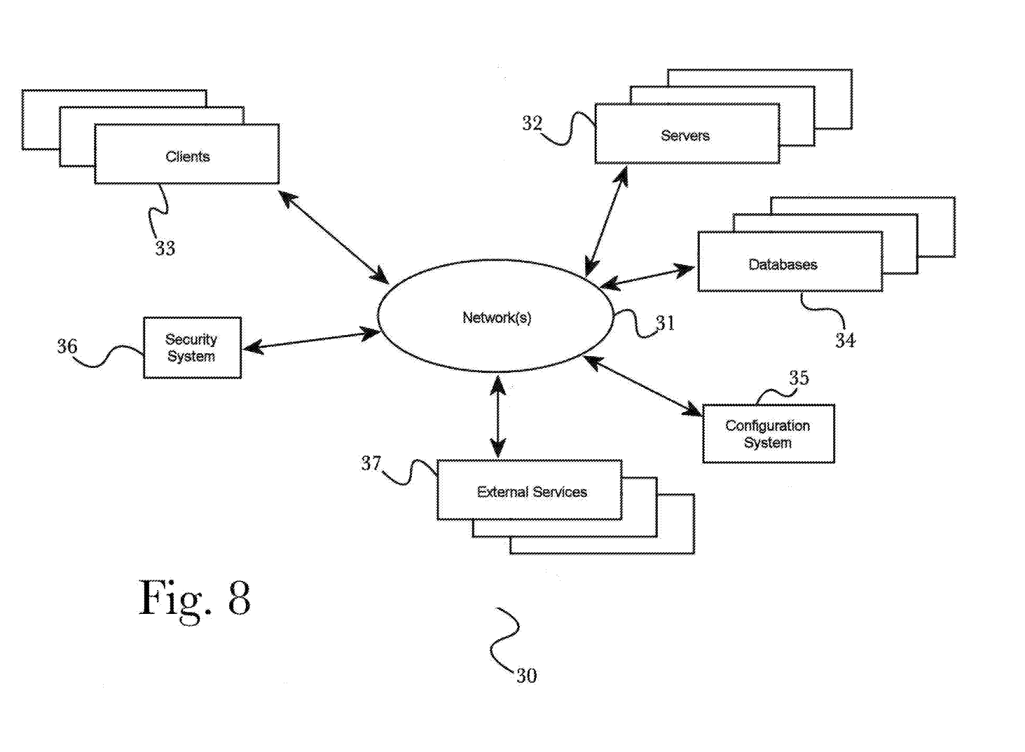

In some embodiments, systems of the present invention may be implemented on a distributed computing network, such as one having any number of clients and/or servers. Referring now to FIG. 8, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 7. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

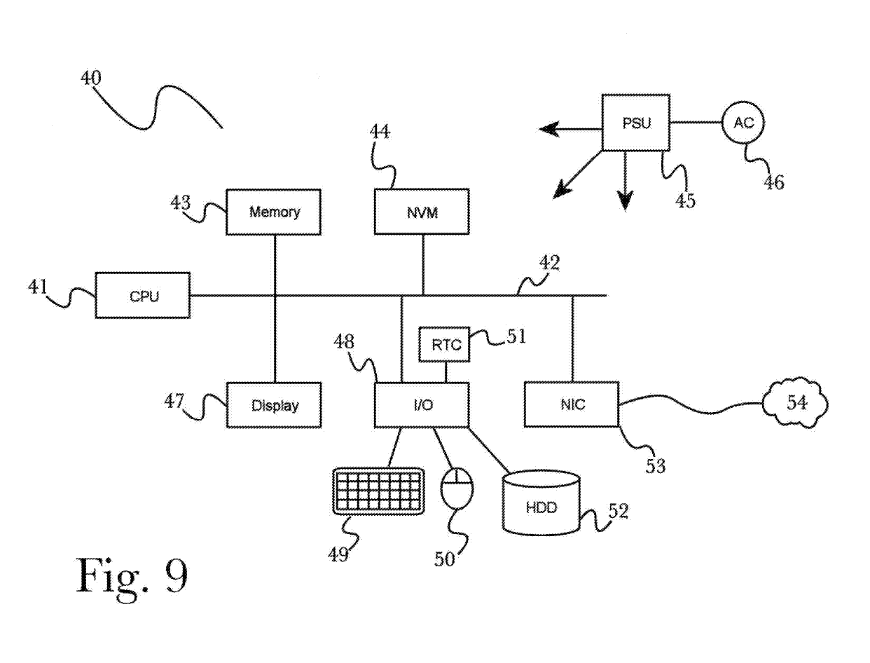

FIG. 9 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for synchronized multi-device mobile gaming, comprising:
a synchronization module comprising at least a plurality of programming instructions stored in a memory and operating on a processor of a network-connected computing device and configured to:
receive at least a game state from a software game application operating on the computing device;
transmit at least a portion of the game state via a network;
receive synchronization data comprising at least a state update message via the network; and
update at least the game state based at least in part on the received synchronization data.

2. The system of claim 1, wherein the computing device is a mobile device.

3. The system of claim 2, wherein the mobile device is a smartphone.

4. The system of claim 2, wherein the synchronization data comprises at least a plurality of sensor data.

5. The system of claim 1, wherein the synchronization module is further configured to receive game data from a gaming source via the network, and is configured to transmit game data a plurality of gaming destination devices via the network.

6. The system of claim 5, wherein the gaming source is a mobile device.

7. The system of claim 5, wherein a gaming destination device is a mobile device.

8. A method for synchronized multi-device mobile gaming, comprising the steps of:
receiving, at a synchronization module comprising at least a plurality of programming instructions stored in a memory and operating on a processor of a network-connected computing device and configured to receive at least a game state from a software application operating on the computing device, and configured to transmit at least a portion of the game state via the network, and configured to receive at least a state update via the network, and configured to update at least the game state based at least in part on the received state update, a plurality of state update messages via a network;
updating at least the operational state of a running software game application based at least in part on at least a portion of the received state update messages; and
transmitting at least the updated operational state via the network.
